(19) United States
(12) Patent Application Publication
(10) Pub. No.: US 2011/0256786 A1
(43) Pub. Date: Oct. 20, 2011

(54) Exterior building wall insulation systems with hygro thermal wrap

(76) Inventor: Mark Bomberg, Ottawa (CA)

(21) Appl. No.: 12/807,730

(22) Filed: Sep. 13, 2010

Related U.S. Application Data
(60) Provisional application No. 61/342,513, filed on Apr. 15, 2010.
(60) Provisional application No. 61/399,497, filed on Jul. 13, 2010.

(51) Int. Cl. B32B 5/02

(52) U.S. Cl. 442/1

(57) ABSTRACT

A composite, layered, thermal insulation and cladding system and method to construct a hygro thermal (HT) wrap. The external insulation system controls the passage of heat, air, liquid water, water vapor, and moisture permeability of the system with the change of the moisture content in some materials. The HT wrap comprises at a material mix applied in two layers, with or without additional surface treatments. The inventive method includes the material combinations and their fiber diameter or particle size in such a manner that the microstructure of HT wrap will provide pore space for retention of the initially added water, permit expansion of the freezing water (thereby improving freeze-thaw durability), provide the interruption in the crack propagation (because the brittle inorganic matrix of the binders is prone to cracking), and provide a degree of elasticity needed to accommodate movements caused by the polyurethane foam or other substrates.

### BACKGROUND OF THE INVENTION

1. Field of Invention

The present invention relates to building materials and more specifically, to a composite exterior insulation system and cladding used in the construction of building walls and structure, to control heat transfer, rain-water penetration, air and water vapor transmission through a building enclosure, and is based upon Provisional Patent Application Ser. Nos. 61/342,513 filed 15 Apr. 2010, and 61/399,497 filed 13 Jul. 2010, each being incorporated herein by reference in their entirety.

2. Description of Prior Art

A building wall's typical exterior insulation layer includes a thermal insulating material covered by a rain intrusion protection layer such as siding or stucco. Thermal insulation material can be impermeable or permeable to water vapor. Stucco can be a “three-coat stucco” (for example, a 3-coat, traditional, metal-lath-reinforced, cladding system) or one-coat stucco (for example, a reinforced portion, applied in two layers) or a modern “synthetic stucco” (for example, a thin lamina reinforced with fiberglass or polymeric mesh) used in Exterior Insulation and Finish Systems (EIFS). Those plasters (stuccos) provide a barrier to rain entry. While the old masonry buildings used renderings with slack lime as the binder and provided substantial capillary action, the renderings based on cement generally use polymeric admixtures which reduces the capillarity of the material. This is reflected in the name of Portland Cement Plaster that replaced the traditional rendering (stucco). In effect, the conventional rain controlling elements in building enclosures are focused on the reduction or elimination of moisture entry into building materials or components. For example, hydrophobic coatings or other film forming compositions may be applied on the exterior surface of Portland Cement Plaster to provide low water transmission, while retaining good flame retarding property and low smoke generation of the plaster. Similarly, a coating of polypropylene resin can be applied to the surface of a fibrous sheet to make the sheet impermeable to water and vapor. Subsequent treatment provides vapor permeability to the sheet while maintaining liquid water impermeability. The resultant product is particularly suited for use as a roofing-tile underlayment or as an air-infiltration barrier. Alternatively, water barriers may be coated with other elastomers, including dispersed layer fillers in liquid carriers, or may include a sheet of paper impregnated with asphalt or urethane compounds. Yet 3-coat Portland Cement Plaster is prone to cracking and subsequent moisture penetration.

On the other hand, “synthetic stucco” (a thin lamina reinforced with fiberglass mesh) is elastic and less prone to cracking but it does not provide sufficient fire protection and drying ability to the wall as well. It lacks the “moisture storage capacity” of the traditional 3-coat lime-cement stucco.

Recently a vapor barrier technology was revolutionized, for instance, one vapor barrier includes polyamide (nylon) fibers that are modified with polyvinyl alcohol. Since these fibers are susceptible to moisture, the water vapor permeance of membrane changes with relative humidity. Another conventional barrier comprises a sheet of a unitary, non-woven material that is spun-bonded from synthetic plexifilamentary fibers. The sheet is then textured with protrusions in a random polyhedral pattern to define channels oriented in multiple directions by which a liquid on the first side of the sheet may drain. A change of similar magnitude is now introduced by the following invention into the Portland Cement Plaster (stucco) type of cladding systems.

### OBJECTS AND ADVANTAGES OF THE PRESENT INVENTION

It is a principal object and advantage of the present invention to provide an external insulating system and a process of construction of that insulating system onto a wall, leading to an assembly for that accelerates drying of moisture encapsulated during construction of the building or the building enclosure.

It is an additional object and advantage of the present invention to provide a system and method for dealing with the moisture that comes from incidental rain leaks at windows or other penetrations or failures of the vapor barrier of a building or its enclosure.

It is a further object and advantage of the present invention to provide an insulated cladding system for new buildings, or retrofit to existing buildings that provides adequate rain water absorption, storage and accelerated water removal capability.

It is another object and advantage of the present invention to provide a system and method for constructing an improved transfer of moisture to an adjacent material layer having a higher activity index or higher storage capability. Other objects and advantages of the present invention will in part be apparent, and in part appear hereinafter.

### BRIEF SUMMARY OF THE INVENTION

The present invention recognizes that building enclosures must be designed differently for warm, mixed and cold climates and therefore the principles defined here may have different representation in each of these climatic regions. Yet, the process of construction covered by this invention comprises two interacting layers: (1) permeable or semi-permeable exterior thermal insulation and (2) a composite called here a hygrothermal or “HT” wrap. Depending on requirements of heat, air and moisture control, the thermal insulating layer may be continuous (spray or poured polyurethane foam) or constructed with boards permeable for water vapor, namely: expanded polystyrene or Eco-fiber boards. The composite “HT” wrap comprise of three layers, namely a bonding layer, a protective layer and a finishing layer. The bonding and protective layers have either identical or almost identical composition so that 3-layer system actually comprise two materials where one of them is applied in two steps.

The objective of this invention is controlling ingress of water, air and water vapor and accelerating the rate of moisture removal from the building enclosure. To this end either a thermal insulating material with measurable drainage ability (eco-fiber board such as wood fiber thermal insulation) or a special drainable thermal insulation (mineral fiber thermal insulation) may use earth gravity force for water removal. Those materials may also be used to enhance diffusion-based drying. As discussed in the section of examples, the mineral fiber insulation is inserted in the layer of spray polyurethane to enhance a combination of drainage and diffusion-based drying. In a parallel system, specially designed HT wrap with Eco-fiber board also provide enhanced capability for drying.

The HT wrap is a material that is Comprised of three components (1) a “binder” that include S-type hydrated lime mixed with natural cement and Portland cement, (2) a “natural fibrous aggregate” such as coming from recycled wood, newsprint or other biological fibers that may be mixed with and post industrial recycled and fiberized materials or post consumer ground glass and (3) a selected “mix of biological and industrial polymers” utilized to provide required dispersion of the recycled materials and bonding to the substrate. The polymer mix determines the moisture retention and the curing rate of the HT wrap.

The substrate can be any construction material that is on the surface of the existing building (direct applied HT wrap) but preferably, the particular design includes three types of thermal insulation materials: (1) bio-fiber insulation boards, (2) polystyrene insulation boards and (3) continuous either sprayed/frothed or poured polyurethane foam, on which surface the HT wrap is applied. Either closed or open cell foams can be used. A reinforcement mesh is placed between the bonding and protective layers of the HT wrap. The mesh is either a metal wire (for example 2.5 oz or 3.4 self-furring lath) or a flexible polymeric mesh (for example, 4 oz or 15 oz fiberglass mesh, permalath, polypropylene etc). The third (finishing) layer may be of a similar nature as the first two or one of the traditional materials used in exterior insulation finishing systems. Any textured and pigmented coating or appropriate paint (mineral oil) can be applied on the top of the finishing layer. The HT wrap may be designed differently for each of the basic climatic zones of for example, the USA.

### BRIEF DESCRIPTION OF THE DRAWINGS

The present invention will be more fully understood and appreciated by reading the following Detailed Description in conjunction with the accompanying drawings, in which:

FIG. 1 is a cross-sectional schematic of thermal insulating material and an “HT” wrap constructed and applied to the wall of a building, according to the principles of the present invention;

FIG. 2 is a graph of: cumulative water inflow vs. square root of time, for several alternative components (mixes C and D) of the present invention;

FIG. 3 is a graph of: drying rate vs. time for modified stucco mixes shown in FIG. 2;

FIG. 4 is a graph representing water absorption rate of modified stucco that uses recycled insulation material (EPS beads);

FIG. 5 is a graph representing drying rates vs. time of the same modified stucco;

FIG. 6 is a cross-sectional schematic of the HT wrap on Eco-fiber board adhered by mortar or adhesive to the wall in a cold climate application; and

FIG. 7 is a cross-sectional schematic of the HT wrap on Eco-fiber board adhered with close cell polyurethane foam to the wall in a warm climate application.

### DETAIL DESCRIPTION OF THE PREFERRED EMBODIMENTS

Referring now to the drawings herein, the numerals refer to parts throughout, for controlling the rate of air, vapor, and liquid water flow across the wall “W” of a building enclosure, as may be seen herein below, in FIG. 1, representing an external insulation system that includes a hygro thermal (HT) wrap 10. The “HT” system shown in FIG. 1 restricts the passage of air and liquid water while permitting the transfer of water vapor to a degree required by the particular climatic conditions. The rate of water vapor transmission across the system is controlled by components of the assembly but it also varies with the moisture content of layers 13 and 14 shown in FIG. 1.

The HT wrap 10 applied to a wall “W”, comprises a bonding layer 13, a protective layer 14 and a finishing layer 15. The bonding layer 13 and the protective layer 14 are preferably identical or nearly identical in composition and thickness and have a thickness of about 3/16 to ¼ in (4 to 6 mm) each and constructed so as to ensure that the reinforcing mesh is placed in the middle of the layered composition. The layers 13 and 14 contain inorganic binders and fillers, for example: lime, cement and fly ash mixed with organic, recycled materials, for example: wood and cellulose fibers fiberized and ground to the particle size as for example: recycled glass mesh 80, generally as needed to accomplish several elements of performance such as (1) provide the required characteristic length allowing for expansion of the freezing water and thereby providing high degree of freeze-thaw durability, (2) provide the interruption in the crack propagation through the brittle inorganic matrix of the stucco and thereby reduce shrinkage and cracking ability (3) provide a degree of elasticity to accommodate movements caused by the structure or gas-filled thermal insulating materials of the HT wrap substrate.

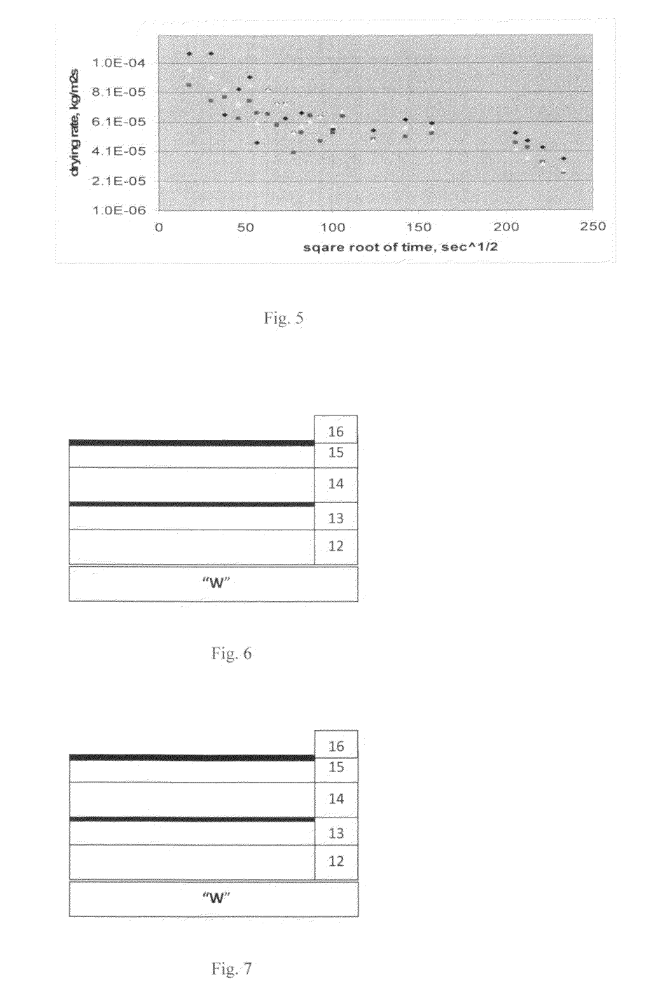

FIG. 1 of The Drawings shows a Schematic drawing of the exterior insulation system that includes the multiple layers 13-16 comprising the “HT” wrap 10, as applied onto insulation 12 on a wall “W”. The layer 12 is a thermal insulation material, such as for example, commercially available Eco-fiber board or mineral fiber board adhered and/or mechanically fastened to the structure of the wall “W”. The layers 13 and 14 of the HT wrap 10 are designed to have the target capillary active, absorbent and hygroscopic performance. The micro-porous system of layers 13 and 14 is inherently a capillary active and hygroscopic material such as for example: modified stucco with recycled insulation shown in FIGS. 4 and 5, with ability to change the rate of moisture transfer with the changes in relative humidity (RH) to which it is exposed. Conversely the layer 15, such as for example: acrylic modified lime-cement finishing coating has hydrophilic properties. The outermost layer 16 is an optional decorative finish. At a low RH, the HT wrap 10 has higher resistance to water vapor diffusion than that at a high RH.

The HT wrap 10, in combination with the three recited thermal insulation types provides a durable water protection under conditions-involving prolonged presence of water and thermal gradients. The required degree of water storage depends on physical properties of the HT wrap layers and considered climate. In cold and mixed climates, the lowermost layers 13 and 14 are preferably enclosed by a thermal insulation on one side and permeable for water vapor finishing layer 15 on the other side. In climates with a frequent interim wetting and drying, the layers 13 and 14 are preferably designed with lower water vapor permeance. Different aggregate compounds may be used to modify moisture characteristics of the layers 13 and 14. An inorganic layered silicate, such as bentonite, vermiculite, or montmorillonite, or selected particulate such as silica, diatomous earth or fly ash can be used for these layers made as a dry premix of binder, recycled aggregate and polymers. The outer layers 15 and/or 16 may also be pre-treated with ingredients which act as biocides e.g., bark of pine tree and enhance protection from microbial deterioration in the form of mold. Other polymeric compounds can also be incorporated into layer 16 to expand the range of control over water, and vapor transport.

Generally, the control of the resistance to liquid water penetration and air while maintaining an ability to transfer water vapor at desired levels is achieved by the pore structure of each layer of the HT wrap 10, as well as by the interface between layers 14 and 15 that constitutes the contrast between the nature of these two layers.

The composite laminate and micro-porous structure of the HT wrap 10 is also less susceptible to shrinkage during drying (typically less than 0.22% after de-molding of the test specimen). Increased water retention of the HT wrap to extend its pot life and eliminate wetting during the curing time makes it resistant to shrinkage cracking and fibrous reinforcement resistant against cracking caused by structural and hygro-thermal movements and deformations. Effectively, the HT wrap 10 has improved resistance to cracking in comparison to conventional stuccos currently used in the exterior insulation systems.

The rate of water vapor transfer needed in a typical construction application depends on both on the climate and service conditions in the specific application. Yet the curing of cement to rapidly achieve initial strength requires high moisture content in the first two days of the service life. To this end selecting adequate type and fraction of admixtures affects the initial water retention of the HT wrap. Furthermore, the composition and micro-porous structure of the layers 13 and 14 as well as inter-face between the layers 14 and 15 dramatically improves the tolerance to poor curing conditions in hot climates. The period of initial water retention in the HT wrap is thus climate dependent and the present inventive HT wrap technology allows us to modify the water retention period during the design of mix. In effect, these possibilities of the selection of the air, water and vapor controlling properties of the HT wraps improve the durability of building wall assemblies.

The present invention thus includes the design of two classes of the HT wrap that are designated for use in various climates, according to standard building specifications. Two extreme classes of the HT wrap 10 differ in their water vapor transmission ability.

The first class of the HT wrap is semi-impermeable for water vapor (WV) and has WV permeability coefficient measured by ASTM E96 dry cup method of between 0.1 perm and 0.5 perm (6 to 28 ng/(m²sPa)) for use in hot and humid climates. With the rate of air transmission of the HT wrap 10 tested at 50 Pa that is lower than 0.02 l/m²sPa, this material is also suitable for air control in hot and humid environments.

The second class of the HT wrap 10 is semi-permeable, and has a water vapor permeability coefficient measured by ASTM E96 dry cup method between 4 perm and 8 perm (230 to 460 ng/(m²sPa) and is suitable for mixed and cold climate applications.

The HT wrap also provides additional protection measures from moisture that is enclosed during the construction process, or that infiltrates from incidental water leakage. For enhanced dissipation of incidental water leakage, the finishing layer (15) or the coating (16) may include a granular finish. The HT wrap may thus be used in many applications where enhanced moisture removal is required, such as walls prone to heavy rain loads, on concrete block walls in basements, or other applications where enhanced drying capability is needed.

### Example 1

### Basic Concepts

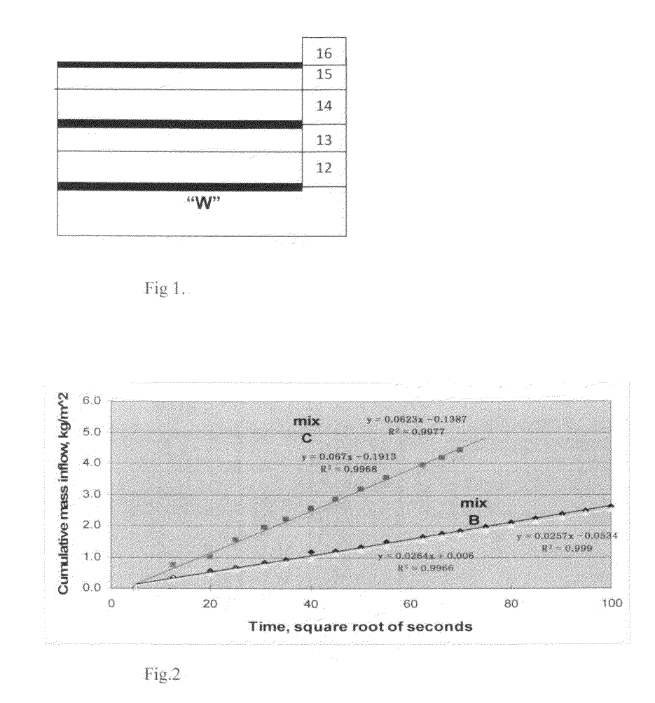

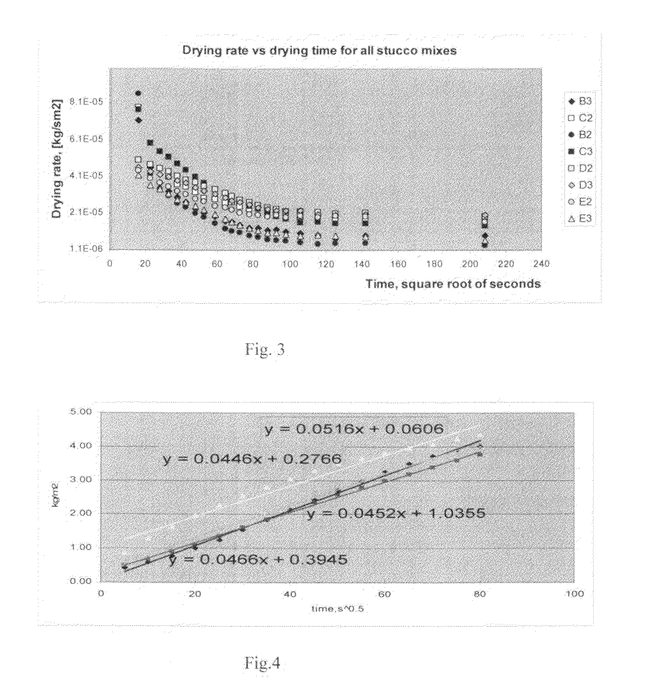

Several laboratory samples of base coat of the HT wrap 10 were prepared and tested. The sample denoted “C” in FIG. 2 was produced with the ratio hydraulic lime:fly ash:cement:sand 1:1:1:6 while sample “B” represent a traditional base-coat of Portland Cement Plaster with the ration cement:lime:sand 1:0.25:4. Mixes C and D, shown in FIGS. 2 and 3 are binder compositions that are used in the following invention. Another mix, shown in FIGS. 4 and 5, also included as a partial subject of this invention used recycled polystyrene beads.

FIG. 2 is a graph with a Lime based binder mix C shows wetting from free water surface faster than mix B that is based on the standard Portland cement. Note that faster wetting also implies faster drying of the rain wetted material.

FIG. 3 is a graph showing Drying rate versus drying time measured on two specimens from different mixes (B-E). Mix B is based on standard Portland Cement, other mixes (C, D, E) are based on lime with varying fraction of insulation aggregate to change product density (e.g. mix D has density of 800 kg/m3).

FIG. 4 is a graph showing Water absorption measured on modified stucco mix with polystyrene beads and density of 170 kg/m³

FIG. 5 is a graph showing Drying rates versus drying time measured on modified stucco shown in FIG. 4.

FIGS. 2-5 thus show that hygric properties can be designed independently of fractions of cement and aggregate.

### Example 2

### An HT wrap on Eco-Fiber Board External Insulation Systems for Cold Climate

Since 1994 flexible and rigid wood-fiber insulation boards have been produced in Germany in accordance with a standard WF-EN 13171-T3-CS (10/Y) 20-TR7, 5-WS2, 0-MU5-AF100. When a multi-fiber system is used as an additive to the wood fibers to modify its physical properties this product is known as “Eco-fiber board”. FIG. 6 shows a system based on application of the rigid Eco-fiber board.

FIG. 6 is a cross-section example of an HT wrap 10, comprising layers 13-16, applied on Eco-fiber board 12 for cold climate application applied to a wall surface “W”.

The layer 12 here is Eco-fiber board from a special run of Homatherm GmbH in Berga, Germany. It has density about 120 kg/m³, a thermal conductivity measured at 10° C. equal to 0.037 W/mK or thermal resistivity of 3.9 (of hr ft²)/BTU in, specific heat 2100 J/(kgK) and thickness 80 mm (3¼ inch). It is adhered to the OSB substrate using Sto Corp manufactured primer/Adhesive placed with a trowel. The HT wrap (the layers 13 and 14) was also manufactured by Sto Corp with the mix designed in accordance with this invention. Glass fiber mesh (5 oz) was placed between the layers 13 and 14. The layer 15 was a StoSilco®Lastic—a ready-mixed, silicone-enhanced, smooth elastomeric exterior wall coating that is weather and mildew-resistant. Total thickness of the HT wrap was 12 mm. No special treatment (16) was used.

### Example 3

### Continuous External Insulation (SPF) Systems for warm climate

FIG. 7 shows an example of an HT wrap 10, comprised of layers 13-16, placed on Eco-fiber board and adhered with close cell polyurethane foam onto a wall surface “W” in warm climate application.

The insulation layer 12 represented here may be made of 1½ inch thick, close or open cell polyurethane foam. This could be either poured foam, applied with a typical 4 ft (1.2 m) height, between extruded polystyrene strips placed on each stud serving as both distance marks and locations of the mechanical fasteners locations or 2 component pressurized froth. In the latter case the maximum height of the insulation board is 2 ft (60 cm). In the actual example 3 different foams from two different manufacturers were used. One of the foams had CCMC 12840-Report that describes the technical features as follows: The final cured product has a nominal density of 30.4 kg/m³ and an assigned design thermal resistance of 1.05 m2·° C./W per 25 mm (R6 per inch). Compressive strength is 222 kPa and tensile strength 337 kPa that is sufficient to ensure adhesion to the substrate and cohesion of the foam.

In this example, the HT wrap had additional admixture of layered silica to reduce its WVT and the finishing layer applied on an HT-wrap was acrylic coating with permeance below 1 perm.

### Example 4

### Continuous External Insulation (SPF) Systems for any Climate

When additional windows are included in the wall rehabilitation, the mechanical loads carried by the exterior insulation may exceed the load bearing capability of the fasteners and specially designed, thermally broken frames are used with eco-fiber board adhered to the wall with spray polyurethane foam but carried by the horizontal shelves. The surface of the Eco-boards is flush with the exterior of the shelves and special tape may be used to cover the board to shelf connections and avoid stress concentration on the HT wrap.

Notes on the Examples of this Invention

This system has a few options that depend on the climatic and service conditions. For 1½ inch thick foam the water vapor permeance of this foam is about 1.5 perm i.e. is semi-permeable. For exposed conditions with coastal climate and high winds it is preferable to use a drainable system with the drainage layer is made out of Eco-fiber board or a mineral fiber as discussed above. This layer is connected to venting and flashing on the level of floor that leads water outwards. For less exposed locations in Central or Western US, an eco-board of the required thickness may be used with poured foam behind it. The mechanical fasteners are typically not required for this option. Use of horizontally placed eco-fiber changes the pattern of work, which namely leads to filling the whole perimeter of the house in horizontal increments of height.

### OVERVIEW OF THE INVENTION

This invention covers a process of construction leading to an external insulating system that accelerates drying of moisture encapsulated during construction of for example, the walls, ceilings, roofs or floors of a building enclosure, or when moisture which comes from condensation or incidental rain leaks at windows or other penetrations of that enclosure. This invention also covers an insulated cladding system for new building construction or an insulation system which is retrofit to the walls, ceilings, roofs or floors of existing buildings in order to provide adequate rain water absorption, storage and removal capability. To accelerate the process of moisture removal while at the same reduce rain wetting capability, one or more of the following measures may be utilized: (1) drainage capability; (2) temporary moisture storage capability, (3) negative wetting angle preventing water flow combine with high water vapor permeance of eco-fiber, (4) sequence of material with a higher activity index or higher storage capability.

The present invention recognizes that building enclosures must be designed differently for various climates and therefore the principles defined in this invention description may have different representation in warm, mixed or cold climates. The process of construction covered by this invention comprises two interacting and in itself often composite layers: (1) exterior thermal insulation and (2) a hygro-thermal (HT) wrap. The thermal insulating layer may be continuous (spray polyurethane foam) or constructed with boards that are permeable for water vapor, such as expanded polystyrene or Eco-fiber boards. If spray foam is used preferably an eco-fiber board or mineral fiber layer with known ability for drainage and diffusion-based drying is included in the exterior insulating system. This system may or may not be open for air flow.

The HT wrap comprises of three layers, namely a bonding layer, a protective layer and a finishing layer. The bonding and protective layers have either identical or almost identical composition so that 3-layer system actually comprise two materials where one of them is applied in two steps.

The external cladding system, as represented in FIG. 1 is called the “HT” wrap 10, that is comprised of: a bonding layer (13) and a protective layer (14), those layers being identical but placed on both sides of the reinforcing mesh and both having capillary active and hygroscopic behavior; and a finishing (15) layer adhered to the protective layer (14) that may or may not be covered with an exterior paint layer (16), wherein the water vapor permeability of this system is directionally sensitive. If water falls on the layer 15 or layer 16, the moisture transmission coefficient is lower than when tested from the inner layer 12 to the exterior layer 16. Furthermore, the intermediate layers 13 and 14 may change water vapor transmission coefficient with a change in moisture content of the material.

The binder in layers 13 and 14 include hydraulic lime modified with natural and Portland cements. The layers 13 and 14 may include at least one compound selected from the group of inorganic layered silicates. The inorganic layered silicate may comprise at least one compound selected from the group consisting of bentonite, vermiculite, montmorillonite and colloidal clay. The inorganic layered silicate may comprise an alkali metal polysilicate solution. The layers 13 and 14 may include at least one compound selected from the group of natural cements. The natural cement may comprise at least one compound selected from the group consisting of fly ashes or pozzolanic materials (metakaolin, ground brick, and enamel glass). The layers 13 and 14 may include at least one compound selected from the group of bio-fibers. The bio-fibers may comprise one fiber type from the group consisting of wood, cellulose, hemp, flax, jute or bamboo. The layers 13 and 14 may include at least one compound selected from the group of regrind/recycled material such as expanded polystyrene coming from molded products such as boards, cups or packaging materials or glass.

This recycled material may be ground to the fiber or particle size as needed, for example, about 60 to about 240 microns to provide the required characteristic length for a number of performance aspects:

1) To allow for expansion of the freezing water and thereby providing high degree of freeze-thaw durability;

2) To provide the interruption in the crack propagation through the brittle inorganic matrix of the stucco;

3) To provide a degree of elasticity to accommodate movements caused by the structure and gas-filled thermal polyurethane foam

The layers 13 and 14 may include at least one compound selected from the group of bio-chemical and industrial surfactants, dispersive and bonding polymers. These polymers may provide multiple functions e.g. hydroxypropyl methyl cellulose not only increases bonding and allows usage of a non-wetting aggregate taken from the recycling but also reduces the volumetric fraction of water added to the dry stucco. The reinforcing mesh, placed between layers 13 and 14 (see FIG. 1) is made either of metal or polymers (fiberglass, polypropylene etc). Any of the layers 13, 14, 15 or 16 may includes a biocide.

The layer 16 is optional. It may include an additional granular admixture or micro-pores to enhance the transport of moisture. The layer 16 may further comprise fillers for improving the radiant barrier properties. The surface finish on the layer 15 may include at least one hygroscopic compound selected from the group consisting of diatomous earth, fly ash, silica powder or ground bark. The layer 15 may be covered with surface finish (16). The surface finish (16) may be comprised of latex acrylic. The surface finish (16) may be comprised of latex rubber. The surface finish (16) may be comprised of mineral oil. The surface finish (16) may be comprising pigments. The HT wrap may have an air permeability rate at 50 Pa lower than 0.021/m²sPa. When measured with the ASTM E96 standard test method—dry cup, the HT wrap may have water vapor permeability of between 0.1 to 0.5 perms (6 to 28 ng/m²sPa) for use in warm climates or up to 10 perms (570 ng/m²sPa) for use in cold climates.

In conclusion, any permeable or semi-permeable external thermal insulating material such as Eco-fiber board, spray polyurethane foam or even expanded polystyrene, when covered with HT wrap to achieve good drying capability, is the subject of this invention. The method of manufacturing an HT wrap comprises the one or more of the steps of:

1. Selecting a mix that is comprised of one or two components from each of the three following groups: (1) a binder that include S-type hydrated lime mixed with natural cements and Portland cement filled, (2) a natural fibrous aggregate such as coming from recycled wood, newsprint or other biological fibers mixed with and post industrial or post consumer ground glass etc, and (3) a selected bio-chemical or/and industrial polymeric admixture to provide required dispersion of the recycled thermal insulation materials and the bonding to the substrate. The mix may or may not include at least one additional compound selected from the group consisting of diatomous earth, silica powder or ground bark. The recycled materials may be fiberized or ground to the size as needed to provide improvement of selected performance aspects.

2. The mix preferably includes at least one compound selected from the group of bio-chemical and industrial surfactants, dispersive and bonding polymers. The polymers may provide a multiple function e.g. hydroxypropyl methyl cellulose not only increases bonding and allows usage of a non-wetting aggregate taken from the recycling and reduces the volumetric fraction of water added to the dry stucco mixture.

3. Applying the mix in two layers, where the second layer may have identical composition but a reinforcing mesh is placed in between them. After adequate drying time the finishing layer is applied.

4. The stucco system may have an air permeability rate at 50 Pa lower than 0.02 l/(m²s Pa). The HT wrap may have a water vapor permeability of between 0.1 to 0.5 perms (6 to 28 ng/m²sPa), class 1, or between 4 and 8 perms (230 to 460 ng/m²sPa), class 2, when measured with the ASTM E96 standard test.

The invention thus comprises an external insulation appliqué system for stepped application to a building wall construction, the system comprising: a layer of permeable or semi-permeable thermal insulation arranged onto the wall of the building, covered with a hygro thermal (HT) wrap consisting initially of three individually applied, climate-dependent layers of: an inner bonding layer arranged onto the layer of thermal insulation; a layer of reinforcing mesh arranged on the inner bonding layer, and a protective layer arranged on the layer of reinforcing mesh, and wherein the inner bonding layer and the protective layer both comprise capillary active and hygroscopic components, wherein the inner bonding layer and the protective layer both comprise capillary active and hygroscopic components, to achieve water resistivity and permit accelerated drying of the exterior insulation system. The layer of thermal insulation is preferably selected from the group comprising: fiber board, open cell polyurethane foam, closed cell polyurethane foam, and expanded polystyrene. The polyurethane foam is preferably applied to both the front and rear sides of the fiber boards, to facilitate drainage and accelerated drying of the exterior insulation system. The inner bonding layer and the protective layer both preferably include a compound of inorganic, layered silicate selected from the group consisting of: bentonite, vermiculite, montmorillonite and colloidal clay. The inorganic layered silicate is preferably comprised of an alkali metal polysilicate solution. The bonding layer and the protective layer preferably include at least one compound selected from the group consisting of: fly ashes and pozzolanic materials consisting of metakaolin, ground brick and glass. The bonding layer and the protective layer include at least one compound preferably selected from a bio-fiber group consisting of: wood, cellulose, hemp, flax, jute and bamboo. The bonding layer and the protective layer may include at least one compound selected from a recycled material consisting of: expanded polystyrene and glass. The bonding layer and the protective layer may include at least one compound selected from a group of consisting of: bio-chemical polymers (extracts from corn, guar gum and sugar cane) from and the industrial polymers such as hydroxypropyl methyl cellulose. The reinforcing mesh layer preferably consists of at least one compound selected from metal and polymers selected from the group consisting of: fiberglass and polypropylene. At least one layer of the hygro-thermal wrap preferably includes a water-retention modifying compound selected from the group consisting of: diatomous earth, fly ash, silica powder and ground bark. The layer of thermal insulation under the hygro wrap consists of a semi permeable film to permit effective drying capability of the building wall under the layer of thermal insulation. At least one of the layers of the hygro thermal wrap may include a biocide compound. The protective layer is preferably covered by a further finish layer selected from the group consisting of: paint pigments, biocides and fillers, comprising the balance of the HT wrap.

I claim:

1. An external insulation appliqué system for stepped application to a building wall construction, the system comprising:
a layer of permeable or semi-permeable thermal insulation arranged onto the wall of the building, covered with a hygro thermal (HT) wrap consisting initially of three individually applied, climate-dependent layers of:
an inner bonding layer arranged onto the layer of thermal insulation;
a layer of reinforcing mesh arranged on the inner bonding layer, and
a protective layer arranged on the layer of reinforcing mesh, and wherein the inner bonding layer and the protective layer both comprise capillary active and hygroscopic components, wherein the inner bonding layer and the protective layer both comprise capillary active and hygroscopic components, to achieve water resistivity and permit accelerated drying of the exterior insulation system.

2. The external insulation system as recited in claim 1, wherein the layer of thermal insulation is selected from the group comprising: fiber board, open cell polyurethane foam, closed cell polyurethane foam, and expanded polystyrene.

3. The external insulation system as recited in claim 2, wherein the polyurethane foam is applied to both the front and rear sides of the fiber boards, to facilitate drainage and accelerated drying of the exterior insulation system.

4. The external insulation system as recited in claim 1, wherein the inner bonding layer and the protective layer both include a compound of inorganic, layered silicate selected from the group consisting of: bentonite, vermiculite, montmorillonite and colloidal clay.

5. The external insulation system as recited in claim 4, wherein the inorganic layered silicate is comprised of an alkali metal polysilicate solution.

6. The external insulation system as recited in claim 1, wherein the bonding layer and the protective layer include at least one compound selected from the group consisting of: fly ashes and pozzolanic materials consisting of metakaolin, ground brick and glass.

7. The external insulation system as recited in claim 1, wherein the bonding layer and the protective layer include at least one compound selected from a bio-fiber group consisting of: wood, cellulose, hemp, flax, jute and bamboo.

8. The external insulation system as recited in claim 1, wherein the bonding layer and the protective layer include at least one compound selected from a recycled material consisting of: expanded polystyrene and glass.

9. The external insulation system as recited in claim 1, wherein the bonding layer and the protective layer include at least one compound selected from a group of consisting of: bio-chemical polymers (extracts from corn, guar gum and sugar cane) from and the industrial polymers such as hydroxypropyl methyl cellulose.

10. The external insulation system as recited in claim 1, wherein the reinforcing mesh layer consists of at least one compound selected from metal and polymers selected from the group consisting of: fiberglass and polypropylene.

11. The external insulation system as recited in claim 1, wherein at least one layer of the hygro-thermal wrap includes a water-retention modifying compound selected from the group consisting of: diatomous earth, fly ash, silica powder and ground bark.

12. The external insulation system as recited in claim 1, wherein the layer of thermal insulation under the hygro wrap consists of a permeable material to permit effective drying capability of the building wall under the layer of thermal insulation.

13. The external insulation system as recited in claim 1, wherein at least one of the layers of the hygro thermal wrap includes a biocide compound.

14. The external insulation system as recited in claim 1, wherein the protective layer of the initial three layers of the hygro thermal wrap is covered by a further layer selected from the group consisting of paint pigments, biocides and fillers.

15. An external insulation system for stepped application to a building construction, the system comprising:
a layer of permeable or semi-permeable thermal insulation arranged onto the wall of the building, covered with a hygro thermal (HT) wrap consisting of three individually applied, climate-dependent layers of:
an inner bonding layer arranged onto the layer of thermal insulation;
a layer of reinforcing mesh arranged on the inner bonding layer,
a protective layer arranged on the layer of reinforcing mesh, and wherein the inner bonding layer and the protective layer both comprise capillary active and hygroscopic components covered by a finish layer of material selected from the group consisting of: paint pigments, fillers, and wherein the inner bonding layer and the protective layer both comprise capillary active and hygroscopic components, to achieve water resistivity and to permit accelerated drying of the exterior insulation system; and
wherein the layer of thermal insulation is selected from the group comprising: fiber board, open cell polyurethane foam, closed cell polyurethane foam, and expanded polystyrene; and
wherein the polyurethane foam is arranged on both the front and rear sides of the fiber boards, to facilitate drainage and accelerated drying of the exterior insulation system.

16. The external insulation system as recited in claim 15, wherein the inner bonding layer and the protective layer both include a compound of inorganic, layered silicate selected from the group consisting of: bentonite, vermiculite, montmorillonite and colloidal clay.
